(19) United States
(12) Patent Application Publication
(10) Pub. No.: US 2025/0235721 A1
(43) Pub. Date: Jul. 24, 2025

(54) Building Rappel Kit

(71) Applicant: William Jay Watson, Bargersville, IN (US)

(72) Inventor: William Jay Watson, Bargersville, IN (US)

(21) Appl. No.: 18/783,608

(22) Filed: Jul. 25, 2024

Related U.S. Application Data
(60) Provisional application No. 63/623,540, filed on Jan. 22, 2024.

(51) Int. Cl. A62B 1/14; A62B 3/00

(52) U.S. Cl. CPC A62B 1/14; A62B 3/005

(57) ABSTRACT

A rappelling device is disclosed which is an emergency rappelling kit that allows a user to rappel down the side of a building that he or she could not otherwise escape in an emergency. The rappelling device comprises a carrying case which would include a glass breaking device, a rappelling harness, an outdoor rock climbing descent device with stop handle control, several carabiners, a spool of cable, a cable guide, gloves, a head lamp, a folding grappling hook, and a respirator. Users secure the cable to an anchor plate. The user puts on the rappelling harness, attaches the handbrake to the harness with the carabiner, puts on the gloves, helmet, headlamp, and respirator when necessary. The user then breaks out the window and tosses the cable spool out, attaches the handbrake to the cable, and rappels down to safety using the hand brake to control the speed of descent.

### CROSS-REFERENCE TO RELATED APPLICATION

The present application claims priority to, and the benefit of, U.S. Provisional Application No. 63/623,540, which was filed on Jan. 22, 2024, and is incorporated herein by reference in its entirety.

### FIELD OF THE INVENTION

The present invention relates generally to the field of rappelling devices. More specifically, the present invention relates to a safety kit for escaping emergency situations in a large building or home. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in rappelling devices. Generally, emergency situations like a building or house fire can be difficult to escape, especially if people are present on upper floors of the building. Further, trying to maneuver through the smoke and fire to reach stairs may be impossible depending on the fire location. Thus, people may be forced to try and jump out windows and scale building exteriors in an attempt to save their life.

The idea of using fire escapes, ladders, scaffolds and the like as evacuation means from burning structures is well known. However, sometimes such fire escapes, ladders, and scaffolds are not available or not able to be used in certain situations. Accordingly, at times other apparatus is needed for permitting users to escape from harm from an upper story of a building during an emergency. These emergency devices need to be portable, have rapidity of deployment, simplicity of use, ease of operation and fingertip control over rate of descent. It should also be light in weight, unusually strong, versatile, durable and have a virtually unlimited shelf-life. The emergency devices need not be inordinately complicated and require elaborate training in their use, the use of the instant device can be easily taught to rescue personnel or learned on the spot by evacuees if necessity warrants.

Accordingly, there is a demand for a rappelling device that functions as a last resort escape method for people who are unable to reach the stairs to evacuate a building. More particularly, there is a demand for a rappelling device that is easily portable and easy to install and use.

Therefore, there exists a long felt need in the art for a rappelling device that provides users with a safety device for escaping emergency situations in a large building or home. There is also a long felt need in the art for a rappelling device that ensures people on upper floors of the building can safely escape should the need arise. Further, there is a long felt need in the art for a rappelling device that features several climbing tools and a rappelling harness, along with other safety and emergency tools like a gas mask and glass breaking tool, that enable the user to rappel down the building exterior to escape. Moreover, there is a long felt need in the art for a device that functions as a last resort escape method for people who are unable to reach the stairs to evacuate a building. Further, there is a long felt need in the art for a rappelling device that allows users to easily transport the kit via an included, durable carrying bag. Finally, there is a long felt need in the art for a rappelling device that is easy to use and install.

The subject matter disclosed and claimed herein, in one embodiment thereof, comprises a rappelling device. The device is an emergency rappelling kit that allows a user to rappel down the side of a building that he or she could not otherwise escape in an emergency. The rappelling device comprises a carrying case which would include a glass breaking device, a rappelling harness, an outdoor rock climbing descent device with stop handle control, several carabiners, a spool of high strength aircraft cable, a cable guide, gloves, a head lamp, a folding grappling hook, a gasmask/respirator, and written instructions or video.

Users secure the cable to an anchor plate or other object with the grappling hook. The user puts on the rappelling harness, attaches the handbrake to the harness with the carabiner, puts on the gloves, helmet, headlamp, and mask/respirator when necessary. The user then breaks out the window with the glass break tool and clears out broken glass with the multi-function tool if necessary. The user then tosses the cable spool out the window or exit way, attaches the handbrake to the cable, and rappels down to safety using the hand brake to control the speed of descent.

In this manner, the rappelling device of the present invention accomplishes all of the forgoing objectives and provides users with a last resort escape method when trying to evacuate a building. The device is a kit that can be easily transported. The device is easy to use and install.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a rappelling device. The device is an emergency rappelling kit that allows a user to rappel down the side of a building that he or she could not otherwise escape in an emergency. The rappelling device comprises a carrying case which would include a glass breaking device, a rappelling harness, a hand brake, several carabiners, a spool of high strength aircraft cable, a cable guide, gloves, a helmet with head lamp, a folding grappling hook, a respirator, and written instructions or video, etc. Users secure the cable to an anchor plate and put on the rappelling harness. Then, they attach the handbrake to the harness with the carabiner, put on the other accessories when necessary. The user then breaks out the window and tosses the cable spool out the window. The user attaches the handbrake to the cable, and rappels down to safety.

In one embodiment, the rappelling device is a portable rappel rescue kit that allows a user to secure a cable, don a harness, and rappel down to safety using a hand brake to control the speed of descent. Thus, the rappelling device functions as a last resort escape device for people who are unable to reach the stairs to evacuate a building.

In one embodiment, the rappelling device comprises a carrying case, which can be a canvas bag or other suitable storage bag which would retain a plurality of tools and other objects needed for rappelling. The carrying case can be any suitable shape and size, as long as it functions to retain the tools and objects within the interior and comprises a means for securing the carrying case, such as a zipper, snaps, Velcro, etc., so nothing is lost or misplaced. Further, when packaged together in the carrying case, the rappelling device and its tools and other objects can be considered and sold as a kit. Any suitable tools and other objects needed for rappelling can be included with the rappelling device, such as the following, but not limited thereto.

In one embodiment, the rappelling device comprises at least one pair of gloves. The gloves are preferably, but not limited to, a pair of heavy-duty leather gloves which act to protect a user's hand and improve a user's grip while rappelling using the device, to prevent injuries. However, the gloves may be made from any suitable material and may be any glove style, such as but not limited to, a belay glove, a half-finger climbing glove, a full-finger climbing glove, etc.

In one embodiment, the rappelling device comprises at least one helmet. The helmet is comprised of at least one battery-powered headlamp (of any style, type, and configuration). Typically, the battery-powered headlamp is positioned at a front of the helmet but could be positioned in any suitable position on the helmet. The helmet is typically light-weight and easy to put on. The helmet would be sized and shaped to fit both men and women. Further, the helmet may be any type and style of helmet that protects a user's head from falling debris. The helmet may also be comprised of at least one safety flasher which may be in the form of a battery-powered flashing light, a reflective marker, etc. The safety flasher helps identify the location of a user while rappelling using the device. The safety flasher is typically positioned at the back of the helmet but can be positioned in any suitable position as is known in the art.

In one embodiment, the rappelling device comprises at least one pair of goggles. The goggles are preferably wrap-around safety goggles but may be any style of safety goggles that protect a user's eyes from debris while rappelling using the device.

In one embodiment, the device is also comprised of at least one respirator that may be any type, including but not limited to, a single-use respirator, a half-face respirator, a full-face respirator, an escape respirator, a cloth mask, a gas mask, etc. The respirator prevents a user from inhaling toxic smoke and/or fumes while rappelling using the device.

In one embodiment, the rappelling device comprises at least one rappelling harness, a high strength cable, at least one carabiner, a hand brake, and a folding grappling hook. These objects allow a user to safely escape emergency situations in a large building or home via rappelling down the building exterior. Specifically, users would secure the high strength cable to an anchor plate, eye hook, or any suitable object that they can find to secure the cable, that can hold weight, such as a column, heavy desk, etc. Typically, the cable is preferably a high-strength, aircraft-grade cable, but may be any cable type suitable for rappelling that allows a user to descend safely, even in the event that there are flames, the cable will remain intact. The cable may be stored on a spool in one embodiment for easy use. Further, in one embodiment, if an anchor plate or eye hook is not available, the foldable grappling hook is used to attach to a window ledge or other suitable surface or area of a building/structure when rappelling. The foldable grappling hook can be any suitable grappling hook as is known in the art and is used when there are no other items to secure the cable to. In one embodiment, a cable guide or placement of an edge guard pad on the building edge, is also used or similar object as is known in the art.

In one embodiment, the user then puts on the harness and secures it to the cable. The harness is lightweight and may be any style of repelling harness, such as but not limited to, a sit harness, a chest harness, a full-body harness, a rescue harness, etc. Typically, the harness has a belt that is adjustable for waist sizes from 22 inches to 50 inches. The harness is also adaptable to be worn in either a waist, seat or chest mode for desired operations. In one embodiment, the harness is attached to at least one hand brake prior to repelling. The hand brake is specified for high strength steel cables and is used to attach the harness to the cable, to allow a user to control their speed during rappelling. The hand brake may be any style of rappelling hand brake that allows a user to control their speed of descent while repelling down the cable, such as but not limited to, a tubular belay device, a figure-eight device, an assisted braking device, a descender, etc. In one embodiment, the harness can be further secured to the hand brake via at least one carabiner (that can hold preferably, but not limited to, at least 300 pounds) of any type, such as but not limited to a screw-lock carabiner, a twist-lock carabiner, a triple-lock carabiner, a wire gate carabiner, a solid gate carabiner, a bent gate carabiner, etc. The carabiner can fasten the harness to the hand brake and is rated to hold at least 300 lbs. during use.

In one embodiment, the device comprises at least one glass breaking tool for breaking a window if necessary, during an emergency evacuation. The glass breaking tool may be any type, style, and configuration of glass breaking tool. Further, the glass breaking tool can be used with a multi-function tool. The multi-function tool can be used to clear out broken glass from the window, or to pry open a window or doorway, etc., or any other job as is necessary. Any suitable multi-function tool can be utilized with the device.

In one embodiment, the device also comprises at least one air horn of any type, style, and configuration that can be used to alert first responders to a user's location. As stated supra, all components of the device can be stored in a storage container or carrying case when not in use.

The container/carrying case may include any style of bag, cover, container, etc. of any suitable material as is known in the art. Further, any other tools and objects can be utilized with the device and stored in the carrying case as is known in the art, depending on the needs and/or wants of a user. For example, other optional items include but are not limited to, an oxygen tank, a 0.5 inch thick L-shaped bracket, a swivel eye snap hook with anchor kit for high strength cable attachment, an outdoor rock climbing descent device with stop handle control, and written instructions and/or an instructional video.

In yet another embodiment, the rappelling device comprises a plurality of indicia.

In yet another embodiment, a method of rappelling to safety in an emergency situation is disclosed. The method includes the steps of providing a rappelling device comprising a carrying case which would include a glass breaking device, a rappelling harness, several carabiners, a hand brake, a spool of cable, a cable guide, gloves, a helmet with head lamp, a folding grappling hook, and a respirator. The method also comprises securing the cable to an anchor plate. Further, the method comprises putting on the rappelling harness, attaching the handbrake to the harness with the carabiner, and putting on the gloves, helmet, headlamp, and respirator when necessary. The method also comprises breaking out the window with the glass break tool and clearing out broken glass with the multi-function tool if necessary. Finally, the method comprises tossing the cable spool out the window or exit way, attaching the handbrake to the cable, and rappelling down to safety using the hand brake to control the speed of descent.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the rappelling device of the present invention showing the device stored in a canvas bag in accordance with the disclosed architecture;

FIG. 2 illustrates a perspective view of one embodiment of the rappelling device of the present invention showing the different tools stored in the canvas bag in accordance with the disclosed architecture;

FIG. 3 illustrates a perspective view of one embodiment of the rappelling device of the present invention showing the additional tools of the device in accordance with the disclosed architecture;

FIG. 4 illustrates a perspective view of one embodiment of the rappelling device of the present invention showing a user utilizing the device in an emergency in accordance with the disclosed architecture;

FIG. 5 illustrates a perspective view of one embodiment of the rappelling device of the present invention showing the device in use in accordance with the disclosed architecture; and

FIG. 6 illustrates a flowchart showing the method of rappelling to safety in an emergency situation in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a rappelling device that provides users with a safety device for escaping emergency situations in a large building or home. There is also a long felt need in the art for a rappelling device that ensures people on upper floors of the building can safely escape should the need arise. Further, there is a long felt need in the art for a rappelling device that features several climbing tools and a rappelling harness, along with other safety and emergency tools like a gas mask and glass breaking tool, that enable the user to rappel down the building exterior to escape. Moreover, there is a long felt need in the art for a device that functions as a last resort escape method for people who are unable to reach the stairs to evacuate a building. Further, there is a long felt need in the art for a rappelling device that allows users to easily transport the kit via an included, durable carrying bag. Finally, there is a long felt need in the art for a rappelling device that is easy to use and install.

The present invention, in one exemplary embodiment, is a novel rappelling device. The rappelling device comprises a carrying case with a variety of tools. The present invention also includes a novel method of rappelling to safety in an emergency situation. The method includes the steps of providing a rappelling device comprising a carrying case which would include a glass breaking device, a rappelling harness, an outdoor rock climbing descent device with stop handle control, several carabiners, a spool of cable, a cable guide, gloves, a head lamp, a folding grappling hook, and a respirator. The method also comprises securing the cable to an anchor plate. Further, the method comprises putting on the rappelling harness, attaching the handbrake to the harness with the carabiner, and putting on the gloves, helmet, headlamp, and respirator when necessary. The method also comprises breaking out the window with the glass break tool and clearing out broken glass with the multi-function tool if necessary. Finally, the method comprises tossing the cable spool out the window or exit way, attaching the handbrake to the cable, and rappelling down to safety using the hand brake to control the speed of descent.

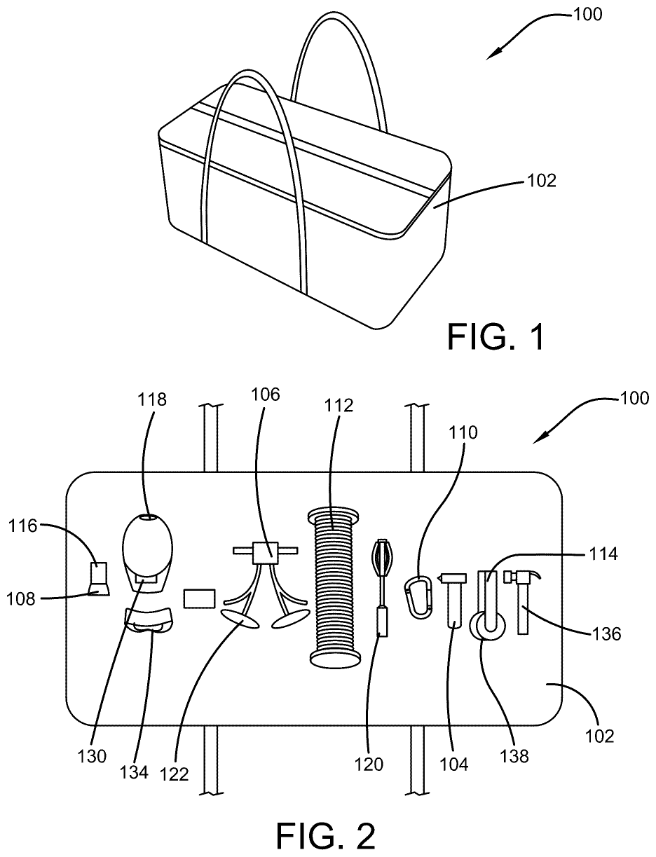

Referring initially to the drawings, FIG. 1 illustrates a perspective view of one embodiment of the rappelling device 100 of the present invention. In the present embodiment, the rappelling device 100 is an improved emergency rappelling kit that allows a user to rappel down the side of a building to escape in an emergency. Specifically, the rappelling device 100 comprises a canvas bag 102 which would include a glass breaking device 104, a rappelling harness 106, a hand brake 108, several carabiners 110, a spool of cable 112, a cable guide 114, gloves 116, a helmet 118, a folding grappling hook 120, and a respirator 122. Users 124 secure the cable 112 to an anchor plate 126 and put on the rappelling harness 106. Then, they attach the hand brake 108 to the harness 106 with the carabiner 110, put on the other accessories when necessary. The user 124 then breaks out the window 128 and tosses the cable spool 112 out the window 128. The user 124 attaches the hand brake 108 to the cable 112, and rappels down to safety.

Generally, the rappelling device 100 is a portable rappel rescue kit that allows a user 124 to secure a cable 112, don a harness 106, and rappel down to safety using a hand brake 108 to control the speed of descent. Thus, the rappelling device 100 functions as a last resort escape device for people who are unable to reach the stairs to evacuate a building.

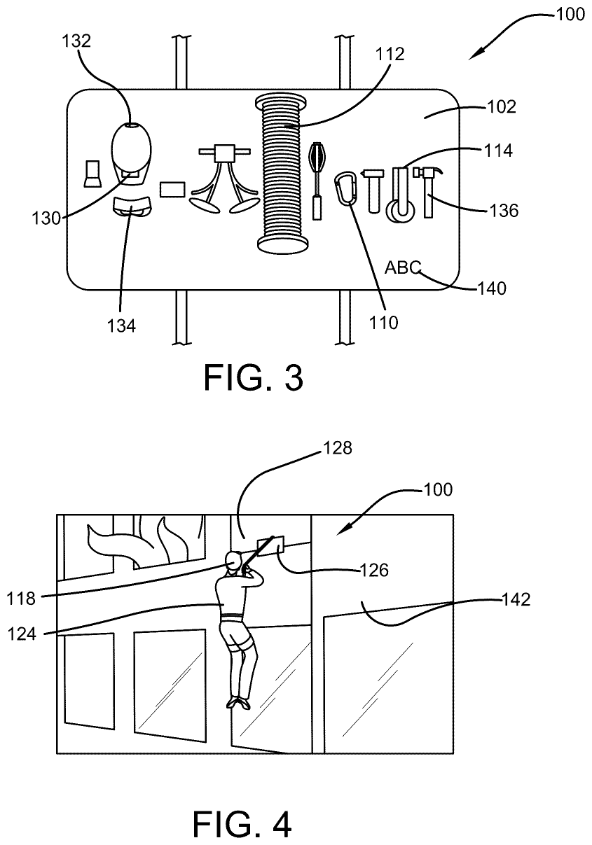

As shown in FIGS. 2-3, the rappelling device 100 comprises a carrying case 102, which can be a canvas bag or other suitable storage bag which would retain a plurality of tools and other objects needed for rappelling. The carrying case 102 can be any suitable shape and size, as long as it functions to retain the tools and objects within the interior and comprises a means for securing the carrying case 102, such as a zipper, snaps, Velcro, etc., so nothing is lost or misplaced. Further, when packaged together in the carrying case 102, the rappelling device 100 and its tools and other objects can be considered and sold as a kit. Any suitable tools and other objects needed for rappelling can be included with the rappelling device 100, such as the following, but not limited thereto.

Further, the rappelling device 100 comprises at least one pair of gloves 116. The gloves 116 are preferably, but not limited to, a pair of heavy-duty leather gloves 116 which act to protect a user's hand and improve a user's grip while rappelling using the device 100, to prevent injuries. However, the gloves 116 may be made from any suitable material and may be any glove style, such as but not limited to, a belay glove, a half-finger climbing glove, a full-finger climbing glove, etc.

Additionally, the rappelling device 100 comprises at least one helmet 118. The helmet 118 is comprised of at least one battery-powered headlamp 130 (of any style, type, and configuration). Typically, the battery-powered headlamp 130 is positioned at a front of the helmet 118 but could be positioned in any suitable position on the helmet 118. The helmet 118 is typically light-weight and easy to put on. The helmet 118 would be sized and shaped to fit both men and women. Further, the helmet 118 may be any type and style of helmet 118 that protects a user's head from falling debris. The helmet 118 may also be comprised of at least one safety flasher 132 which may be in the form of a battery-powered flashing light, a reflective marker, etc. The safety flasher 132 helps identify the location of a user 124 while rappelling using the device 100. The safety flasher 132 is typically positioned at the back of the helmet 118 but can be positioned in any suitable position as is known in the art.

Furthermore, the rappelling device 100 comprises at least one pair of goggles 134. The goggles 134 are preferably wrap-around safety goggles 134 but may be any style of safety goggles 134 that protect a user's eyes from debris while rappelling using the device 100.

Additionally, the device 100 is also comprised of at least one respirator 122 that may be any type, including but not limited to, a single-use respirator, a half-face respirator, a full-face respirator, an escape respirator, a cloth mask, a gas mask, etc. The respirator 122 prevents a user 124 from inhaling toxic smoke and/or fumes while rappelling using the device 100.

Further, the device 100 comprises at least one glass breaking tool 104 for breaking a window 128 if necessary, during an emergency evacuation. The glass breaking tool 104 may be any type, style, and configuration of glass breaking tool 104. Further, the glass breaking tool 104 can be used with a multi-function tool 136. The multi-function tool 136 can be used to clear out broken glass from the window 128, or to pry open a window 128 or doorway, etc., or any other job as is necessary. Any suitable multi-function tool 136 can be utilized with the device 100.

Furthermore, the device 100 also comprises at least one air horn 138 of any type, style, and configuration that can be used to alert first responders to a user's location. As stated supra, all components of the device 100 can be stored in a storage container or carrying case 102 when not in use. The container/carrying case 102 may include any style of bag, cover, container, etc. of any suitable material as is known in the art. Further, any other tools and objects can be utilized with the device 100 and stored in the carrying case 102 as is known in the art, depending on the needs and/or wants of a user 124. For example, other optional items include but are not limited to, an oxygen tank, a 0.5 inch thick L-shaped bracket, a swivel eye snap hook with anchor kit for high strength cable attachment, an outdoor rock climbing descent device with stop handle control, and written instructions and/or an instructional video, etc.

In yet another embodiment, the rappelling device 100 comprises a plurality of indicia 140. The carrying case 102 of the device 100 may include advertising, a trademark, or other letters, designs, or characters, printed, painted, stamped, or integrated into the carrying case 102, or any other indicia 140 as is known in the art. Specifically, any suitable indicia 140 as is known in the art can be included, such as but not limited to, patterns, logos, emblems, images, symbols, designs, letters, words, characters, animals, advertisements, brands, etc., that may or may not be rappelling, emergency, or brand related.

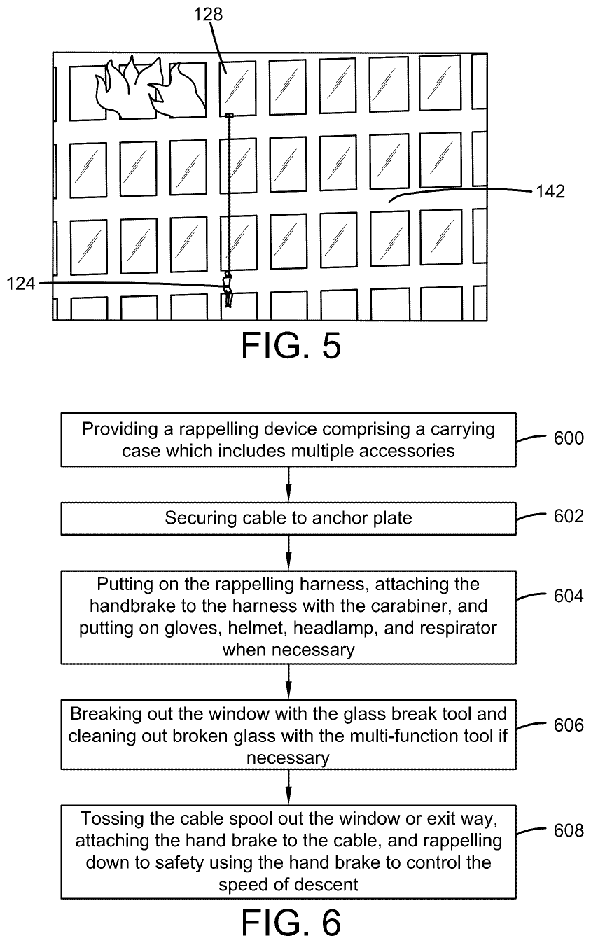

As shown in FIGS. 4-5, the rappelling device 100 comprises at least one rappelling harness 106, a high strength cable 112, at least one carabiner 110, a hand brake 108, and a folding grappling hook 120. These objects allow a user 124 to safely escape emergency situations in a large building 142 or home via rappelling down the building exterior 142. Specifically, users 124 would secure the high strength cable 112 to an anchor plate 126, eye hook, or any suitable object that they can find to secure the cable 112, that can hold weight, such as a column, heavy desk, etc. Typically, the cable 112 is preferably a high-strength, aircraft-grade cable, but may be any cable 112 type suitable for rappelling that allows a user 124 to descend safely, even in the event that there are flames, the cable 112 will remain intact. The cable 112 may be stored on a spool in one embodiment for easy use. Further, in one embodiment, if an anchor plate 126 or eye hook is not available, the foldable grappling hook 120 is used to attach to a window ledge or other suitable surface or area of a building/structure 142 when rappelling. The foldable grappling hook 120 can be any suitable grappling hook 120 as is known in the art and is used when there are no other items to secure the cable 112 to. In one embodiment, a cable guide 114 or placement of an edge guard pad on the building edge, is also used or similar object as is known in the art.

Furthermore, the user 124 then puts on the harness 106 and secures it to the cable 112. The harness 106 is lightweight and may be any style of repelling harness, such as but not limited to, a sit harness, a chest harness, a full-body harness, a rescue harness, etc. Typically, the harness 106 has a belt that is adjustable for waist sizes from 22 inches to 50 inches. The harness 106 is also adaptable to be worn in either a waist, seat or chest mode for desired operations. In one embodiment, the harness 106 is attached to at least one hand brake 108 prior to repelling. The hand brake 108 is specified for high strength steel cables 112 and is used to attach the harness 106 to the cable 112, to allow a user 124 to control their speed during rappelling. The hand brake 108 may be any style of rappelling hand brake 108 that allows a user 124 to control their speed of descent while repelling down the cable 112, such as but not limited to, a tubular belay device, a figure-eight device, an assisted braking device, a descender, etc. In one embodiment, the harness 106 can be further secured to the hand brake 106 via at least one carabiner 110 (that can hold preferably, but not limited to, at least 300 pounds) of any type, such as but not limited to a screw-lock carabiner, a twist-lock carabiner, a triple-lock carabiner, a wire gate carabiner, a solid gate carabiner, a bent gate carabiner, etc. The carabiner 110 can fasten the harness 106 to the hand brake 108 and is rated to hold at least 300 lbs. during use.

FIG. 6 illustrates a flowchart of the method of rappelling to safety in an emergency situation. The method includes the steps of at 600, providing a rappelling device comprising a carrying case which would include a glass breaking device, a rappelling harness, several carabiners, a hand brake, a spool of cable, a cable guide, gloves, a helmet with head lamp, a folding grappling hook, and a respirator. The method also comprises at 602, securing the cable to an anchor plate. Further, the method comprises at 604, putting on the rappelling harness, attaching the handbrake to the harness with the carabiner, and putting on the gloves, helmet, headlamp, and respirator when necessary. The method also comprises at 606, breaking out the window with the glass break tool and clearing out broken glass with the multi-function tool if necessary. Finally, the method comprises at 608, tossing the cable spool out the window or exit way, attaching the handbrake to the cable, and rappelling down to safety using the hand brake to control the speed of descent.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “rappelling device” and “device” are interchangeable and refer to the rappelling device 100 of the present invention.

Notwithstanding the forgoing, the rappelling device 100 of the present invention can be of any suitable size and configuration as is known in the art without affecting the overall concept of the invention, provided that it accomplishes the above stated objectives. One of ordinary skill in the art will appreciate that the rappelling device 100 as shown in FIGS. 1-6 is for illustrative purposes only, and that many other sizes and shapes of the rappelling device 100 are well within the scope of the present disclosure. Although the dimensions of the rappelling device 100 are important design parameters for user convenience, the rappelling device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A rappelling device that allows a user to rappel down the side of a building to escape in an emergency, the rappelling device comprising:
a carrying case; and
a plurality of accessories;
wherein the plurality of accessories is stored within the carrying case for ease in transport;
wherein the plurality of accessories comprises a cable, a harness, a hand brake, at least one carabiner, and a folding grappling hook; and
further wherein a user secures the cable and puts on the harness, and then the user attaches the hand brake to the cable and rappels down to safety.

2. The rappelling device of claim 1, wherein the plurality of accessories comprises at least one pair of gloves.

3. The rappelling device of claim 2, wherein the pair of gloves are heavy-duty leather gloves to protect a user's hand while rappelling using the device.

4. The rappelling device of claim 3, wherein the plurality of accessories comprises at least one helmet.

5. The rappelling device of claim 4, wherein the helmet comprises at least one battery-powered headlamp positioned at a front of the helmet.

6. The rappelling device of claim 5, wherein the helmet comprises at least one safety flasher positioned at a back of the helmet.

7. The rappelling device of claim 6, wherein the plurality of accessories comprises at least one pair of goggles.

8. The rappelling device of claim 7, wherein the goggles are wrap-around safety goggles.

9. The rappelling device of claim 8, wherein the plurality of accessories comprises at least one respirator.

10. The rappelling device of claim 9, wherein the plurality of accessories comprises at least one glass breaking tool for breaking a window.

11. The rappelling device of claim 10 wherein the plurality of accessories comprises at least one multi-function tool for clearing out broken glass from a window or to pry open a window or doorway.

12. The rappelling device of claim 11 wherein the plurality of accessories comprises at least one air horn to alert first responders to a user's location.

13. The rappelling device of claim 12 wherein the plurality of accessories comprises written instructions or an instructional video.

14. A rappelling device that allows a user to rappel down the side of a building to escape in an emergency, the rappelling device comprising:
a carrying case; and
a plurality of accessories;
wherein the plurality of accessories is stored within the carrying case for ease in transport;
wherein the plurality of accessories comprises a cable, a harness, a hand brake, at least one carabiner, and a folding grappling hook;
wherein a user secures the cable and puts on the harness to rappel to safety;
wherein the harness is attached to the hand brake prior to repelling and is used to attach the harness to the cable; and
further wherein the at least one carabiner fastens the harness to the hand brake to control the speed of descent.

15. The rappelling device of claim 14 further comprising a plurality of indicia.

16. The rappelling device of claim 14, wherein the cable is secured to an anchor plate, an eye hook, or other object that can hold weight.

17. The rappelling device of claim 16, wherein if the anchor plate or eye hook are not available, the foldable grappling hook is used to attach to a window ledge.

18. The rappelling device of claim 17, wherein a cable guide is utilized during rappelling.

19. The rappelling device of claim 18, wherein the at least one carabiner is rated to hold at least 300 pounds.

20. A method of rappelling to safety in an emergency situation, the method comprising the following steps:
providing a rappelling device comprising a carrying case which would include a glass breaking device, a rappelling harness, several carabiners, a hand brake, a spool of cable, a cable guide, gloves, a helmet with head lamp, a folding grappling hook, and a respirator; securing the cable to an anchor plate;
putting on the rappelling harness, attaching the handbrake to the harness with the carabiner, and putting on the gloves, helmet, headlamp, and respirator when necessary;
breaking out the window with the glass break tool and clearing out broken glass with the multi-function tool if necessary; and
tossing the cable spool out the window or exit way, attaching the handbrake to the cable, and rappelling down to safety using the hand brake to control the speed of descent.
